(19) United States
(12) Patent Application Publication
(10) Pub. No.: US 2026/0222720 A1
(43) Pub. Date: Jul. 30, 2026

(54) SPEAKER AND ELECTRONIC DEVICE

(71) Applicant: HARMAN INTERNATIONAL INDUSTRIES, INCORPORATED, Stamford, CT (US)

(72) Inventors: Yuanzhen NIU, Shenzhen, Guangdong (CN); Jihui ZENG, Shenzhen, Guangdong (CN); Zhenjin ZHU, Shenzhen, Guangdong (CN); Yadi WANG, Shenzhen, Guangdong (CN)

(73) Assignee: HARMAN INTERNATIONAL INDUSTRIES, INCORPORATED, Stamford, CT (US)

(21) Appl. No.: 19/146,710

(22) PCT Filed: Jan. 31, 2023
(86) PCT No.: PCT/CN2023/073971

§ 371 Date: Jul. 9, 2025

(51) Int. Cl. H04R 1/08; H04R 7/18; H04R 9/02; H04R 9/04; H04R 9/06

(52) U.S. Cl. CPC H04R 1/08; H04R 7/18; H04R 9/025; H04R 9/043; H04R 9/06; H04R 2400/11

(57) ABSTRACT

A speaker and an electronic device are disclosed. The speaker comprises: a magnet assembly defining a magnetic gap; a frame fixedly attached to the magnet assembly; a vibration assembly, comprising a diaphragm and a voice coil, the voice coil being attached to the diaphragm and being configured to vibrate with the diaphragm, the voice coil having a coil portion that is at least partially suspended in the magnetic gap, and a vibration supporting member disposed between the vibration assembly and the frame and connecting the vibration assembly to the frame, wherein the vibration member is formed with conductors which are electrically connected to the coil portion of the voice coil. The electronic device comprises one or more speakers.

### CROSS-REFERENCE TO RELATED APPLICATIONS

This application is the U.S. National Phase Entry of International Application No. PCT/CN2023/073971 filed on Jan. 31, 2023, which is hereby incorporated in its entirety by reference herein.

### TECHNICAL FIELD

The present disclosure relates generally to a speaker and an electronic device comprising a speaker.

### BACKGROUND

With the continuous development of electronic technology and the increasing demands of customers, the requirements for speakers have also been increasing. For example, the speakers may need to meet the following requirements while being in a low profile: large bearing power, large displacement, low distortion, an audio output with higher sensitivity and a high frequency extension.

Currently, an existing conventional speaker comprises two separate or suspended lead wires extending from a voice coil to frame terminals of the speaker to receive an audio signal. The lead wires should be axially spaced from a surround and/or spider of the speaker, and space has to be reserved above and below the lead wires, so as to keep the lead wires clear of other parts and to prevent a potential collision during operation of the speaker, which makes it difficult to design or manufacture a low-profile speaker. In addition, when manufacturing the speaker, in order to ensure a proper operation of the speaker and to avoid abnormal sound or noise, the lead wires should be soldered to the frame terminals of the speaker so that there is an accurate length and a bending arc of the lead wires between the voice coil and the frame terminals. The step of controlling or adjusting the length and a bending arc of the lead wires between the voice coil and the frame terminals is complex and difficult. In actual production, it is almost impossible to completely avoid defects or poor performance of speakers due to inaccurate length or bending arc of the lead wires.

Therefore, there is a need for a speaker that can meet the above requirements, especially the requirement for a low-profile and/or easy manufacturing.

### SUMMARY OF THE INVENTION

According to one aspect of the disclosure, a speaker is provided, comprising:
a magnet assembly defining a magnetic gap;
a frame fixedly attached to the magnet assembly;
a vibration assembly, comprising a diaphragm and a voice coil, the voice coil being attached to the diaphragm and being configured to vibrate with the diaphragm, the voice coil having a coil portion that is at least partially suspended in the magnetic gap, and
a vibration supporting member disposed between the vibration assembly and the frame and connecting the vibration assembly to the frame,
wherein the vibration member is formed with conductors which are electrically connected to the coil portion of the voice coil.

According to another aspect of the disclosure, an electronic device is provided, comprising one or more speakers.

Other systems, methods, features and advantages of the disclosure will be, or will become, apparent to those skilled in the art upon reading of the following figures and detailed description. It is intended that all such additional systems, methods, features, and advantages be included in this description, be within the scope of the disclosure, and be protected by the following claims.

### BRIEF DESCRIPTION OF THE DRAWINGS

The present disclosure will be better understood by reference to the following drawings and description. The components shown in the drawings are not necessarily to scale, instead, emphasis should be placed upon the principles illustrated by the disclosure. Moreover, in the figures, like reference numerals designate like parts throughout the drawings.

FIG. 1 is a sectional view showing a speaker according to one or more embodiments of the present disclosure;

FIG. 2 is an enlarged view of a circled portion of FIG. 1;

FIG. 3A is a top view of a surround of the speaker, and FIG. 3B is a bottom view of the surround according to one or more embodiments of the present disclosure;

FIG. 4A is a bottom view of the surround according to one or more embodiments of the present disclosure;

FIG. 4B is a bottom view of the surround according to one or more other embodiments of the present disclosure;

FIGS. 5A-5B show a surround according to one or more other embodiments of the present disclosure, wherein FIG. 5A is a top view of the surround and FIG. 5B is a bottom view of the surround;

FIGS. 6A-6B show a surround according to one or more still other embodiments of the present disclosure, wherein FIG. 6A is a top view of the surround and FIG. 6B is a bottom view of the surround; and

FIG. 7 is a sectional view showing a speaker according to one or more embodiments of the present disclosure.

### BRIEF DESCRIPTION OF THE PREFERRED EMBODIMENTS

Hereinafter, various embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc. may be used herein to describe various elements, components, steps or calculations, these elements, components, steps, or calculations should not be limited by these terms, rather these terms are only used to distinguish one element, component, step or calculation from another. For example, a first component may be referred to as a second component, similarly a first calculation may be referred to as a second calculation; similarly, a first step may be referred to as a second step; all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

As used herein, the term “axis” corresponds to a central axis passing through the speaker, the vibration assembly or the surround, the term “axial direction” means a direction along the axis. The term “inner” or “inner portion” means a direction, a position, or a portion that is relatively closer to the axis and the term “outer” or “outer portion” means a direction, a position or a portion that is relatively away from the axis. The term “vibration supporting member” corresponds to a member that supports the diaphragm and/or the voice coil, such as a surround or a spider. Normally, the vibration supporting member is connected at one end to the diaphragm and/or the voice coil and is connected at the other end to the frame of the speaker, and thus can support or position the diaphragm and/or the voice coil in their proper positions.

The present disclosure provides a speaker and an electronic device comprising one or more speakers. In the speaker, conductors for transmitting an audio signal from an external audio source to the voice coil are formed with a vibration supporting member, such as a surround or a spider of the speaker. Therefore, there is no separate or suspended lead wire in the speaker, and thus the speaker has a reduced height as compared to a conventional speaker having separate or suspended lead wires. In addition, the process of manufacturing a speaker may be simplified by omitting the complex step of controlling or adjusting the length and bending arc of the lead wires between the voice coil and the frame terminals.

According to one or more embodiments of the present disclosure, the conductors and the vibration supporting member, such as a surround or a spider, are formed as an integral part by a vulcanization molding process. The conductors are encapsulated in and can be well protected by the rubber material of the surround. Compared with other processes, the conductors encapsulated in the surround formed by a vulcanization molding process have an elongate lifetime and a noise associated with the conductors is reduced or eliminated.

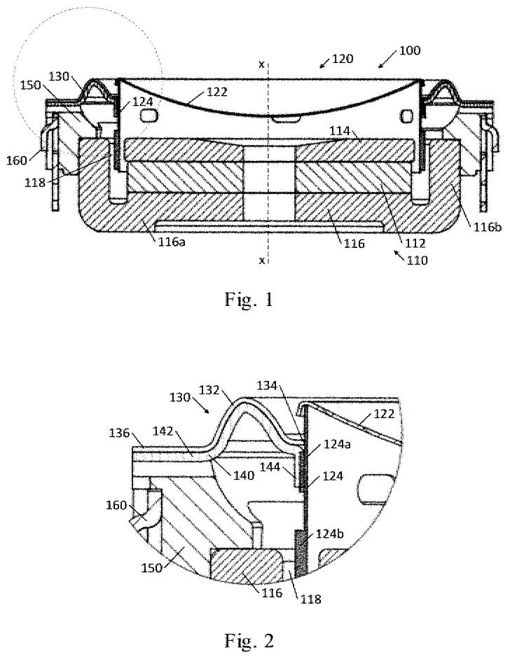

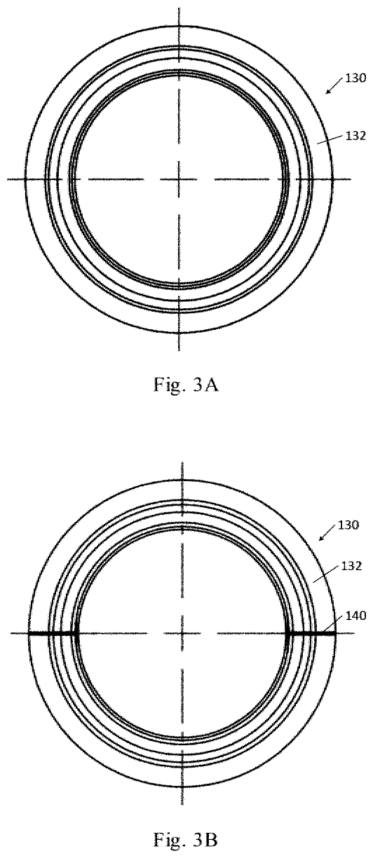

FIG. 1 is a sectional view showing a speaker 100 according to one or more embodiments of the present disclosure. FIG. 2 is an enlarged view of a circled portion of FIG. 1. FIG. 3A is a top view of a surround 130 of the speaker 100, and FIG. 3B is a bottom view of the surround 130.

As shown, the speaker 100 comprises an axis x, a magnet assembly 110, a vibration assembly 120, a surround 130 and a frame 150. The magnet assembly 110 comprises a magnet 112, a top plate 114, a yoke 116 and a magnetic gap 118 formed between the top plate 114 and the yoke 116. The yoke 116 has a yoke base 116a and side walls 116b extending from the yoke base 116a, defining a space for receiving the magnet 112 and the top plate 114 therein. The magnet assembly is arranged such that the top plate 114 and the yoke 116 direct and concentrate the magnetic flux from the magnet 112 to and through the magnetic gap 118. The frame 150 is fixedly coupled to the magnet assembly 110 or the yoke 116 of the magnet assembly.

The vibration assembly 120 comprises a diaphragm 122 and a voice coil 124. The voice coil 124 is connected to the diaphragm 122 and thus moves or vibrates together with the diaphragm 122. The voice coil 124 comprises a body portion 124a and a coil portion 124b attached to the body portion 124a. The coil portion 124b is at least partially suspended in the magnetic gap 118. In some embodiments of the present disclosure, the voice coil 124 is connected at its upper end to the diaphragm 122 and the coil portion 124b that is suspended in the magnetic gap 118 is a lower portion of the voice coil 124. The surround 130 comprises a surround body 132 and is formed with conductors 140. The surround 130 or the surround body 132 is connected at its inner end 134 to the voice coil 124 and is connected at its outer end or outer portion 136 to the frame 150. The conductors 140 are electrically connected to the coil portion 124b of the voice coil 124. During operation, an audio signal is transmitted through the conductors 140 to the voice coil 124. The voice coil 124 vibrates in the magnetic gap 118 in response to the audio signal passing through the voice coil 124 in the magnetic gap 118, causing the diaphragm 122 connected to the voice coil 124 to vibrate to emit sound.

FIGS. 1-2 show specific structures of the magnet assembly 110 and the frame 150 according to one or more embodiments of the present disclosure. However, the present disclosure is not limited thereto. In one or more other embodiments of the present disclosure, the magnet assembly may have any suitable structure as long as the magnet assembly can define a magnetic gap for the voice coil to be suspended therein and can direct and concentrate the magnetic flux from the magnet to and through the magnetic gap. In one or more further embodiments of the present disclosure, the frame may have any suitable structure as long as it can support the surround and the vibration assembly. In one or more further embodiments of the present disclosure, the frame 150 may be omitted and the surround 130, i.e., the outer end or outer portion 136 of the surround 130, may be directly connected to the magnet assembly.

As shown in FIGS. 1-2, each of the conductors 140 comprises a conductor body 142 that is snugly attached to the surround body 132 along its entire length. That is, the conductor body 142 is in close contact with and is connected to the surround body 132 along its entire length and vibrates with the surround during operation of the speaker 100. Each of the conductors 140 also comprises a connection portion 144 at its inner end. The connection portion 144 is attached to the voice coil 124 and is electrically connected to the coil portion 124b and thus the conductor 140 is electrically connected to the coil portion 124b. Each of the conductors 140 is also electrically connected to a respective terminal 160, which in turn is configured to be electrically connected to an external audio source. Particularly, the connection portions 144 of the two conductors 140 are electrically connected to a positive lead and a negative lead of the voice coil 124 respectively, and the two conductors 140 are electrically connected to a positive terminal and a negative terminal respectively. In other words, the conductors 140 are connected to the surround 130 and co-extend with the surround 130 at least along an extension length of the surround from the voice coil 124 to the frame 150. During operation of the speaker 100, the voice coil 124 receives an audio signal from an external audio source through the terminal 160 and the conductors 140.

Thus, in the embodiments shown in FIGS. 1-2, the conductors 140 for transmitting an audio signal to the voice coil 124 are formed with the surround 130, and there is no separate or suspended lead wire in the speaker 100. Therefore, the speaker 100 has a reduced height as compared to a conventional speaker having separate or suspended lead wires. In addition, since there is no separate or suspended lead wire, the process of manufacturing a speaker can be simplified by omitting the complex or difficult step of controlling or adjusting the length and bending arc of the lead wires between the voice coil and the frame terminals.

As shown in FIGS. 1-2, 3A-3B, the conductors 140 are formed in the surround 130, closer to or partially exposed from the bottom surface of the surround 130. In some embodiments of the present disclosure, the surround is thickened in areas near or adjacent to the conductors to at least partially encapsulate the conductors 140 therein. In one or more embodiments of the present disclosure, the surround is thickened only in small areas near or adjacent to the conductors and the performance of the surround is not affected by the localized thickening of the surround, especially when the conductors and the thickened areas are arranged symmetrically with respect to the center of the surround. As used herein, the term “encapsulate”, “encapsulated”, “partially encapsulated” and “completely encapsulated” indicate that the conductor body 142 is encapsulated, partially encapsulated or completely encapsulated in the surround 130, although the inner end or portion (connection portion 144) of each conductor 140 extends out of the surround to be connected to the lead of the voice coil and the outer end or portion (not shown) of each conductor 140 extends out of the surround to be connected to the terminals of the speaker.

In one or more embodiments of the present disclosure, the conductors 140 and the surround 130 are integrally formed by a vulcanization molding process. In some embodiments, the molding process may comprise the steps of: forming grooves in a mold at positions corresponding to the conductors; positioning or fixing the conductors in corresponding grooves in the mold; applying raw rubber material into the mold; applying heat and/or pressure to vulcanize the rubber so that an integral surround is formed with the conductors encapsulated in the surround.

In the embodiments where the conductors 140 and the surround 130 are formed as an integral part, such as by a vulcanization molding process, the conductors are encapsulated in and can be well protected by the rubber material of the surround. For example, any shock or force to the conductors can be cushioned or at least partially absorbed by the rubber material encapsulating the conductors. It is disclosed in the present disclosure that, as compared to other processes, the conductors encapsulated in the surround by a vulcanization molding process have an extended or elongate lifetime without any failure, such as a breakage or disconnection of the conductors. In addition, because the conductors are encapsulated in the rubber material of the surround, a noise associated with the conductors is reduced or eliminated.

In the embodiments shown in FIGS. 1-2, 3A-3B, the two conductors 140 are arranged symmetrically with respect to the center of the surround 130 or the axis of the speaker 100. However, the present disclosure is not limited thereto, in one or more other embodiments of the present disclosure, the two conductors can be positioned in any suitable relationship. For example, the two conductors can be positioned at any suitable angle with respect each other, such as an angle of 90 degrees. The two conductors can also be positioned in a parallel relationship, a vertical relationship or a coincident relationship.

In the embodiments shown in FIGS. 1-2, 3A-3B, each of the two conductors 140 is a single stranded round wire. However, the present disclosure is not limited thereto. In one or more other embodiments of the present disclosure, the conductors may be in any suitable form, such as stranded wires, flat wires, metal films, or metal meshes.

In the embodiments shown in FIGS. 1-2, 3A-3B, the conductors 140 and the surround 130 are formed as an integral part by a vulcanization molding process.

However, the present disclosure is not limited thereto. In one or more other embodiments of the present disclosure, the conductors may be attached to the surround by any suitable method, such as weaving or adhesive bonding. In the embodiments shown in FIGS. 1-2, 3A-3B, the surround 130 are formed of vulcanized rubber, such as PU or foam. However, the present disclosure is not limited thereto. In one or more other embodiments of the present disclosure, the surround 130 may be formed of any suitable material.

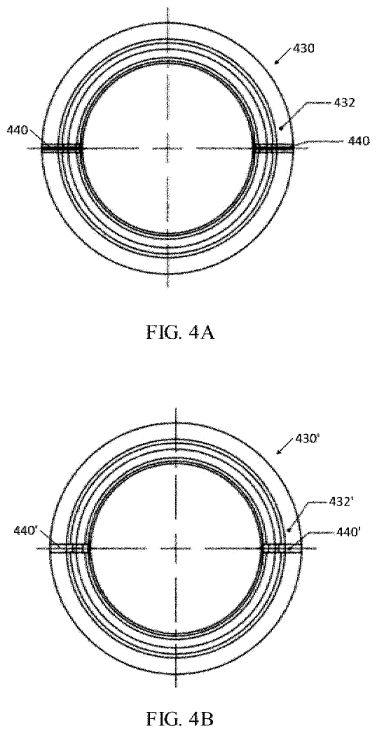

FIG. 4A is a bottom view of the surround 430 according to one or more embodiments of the present disclosure. The surround 430 comprises a surround body 432 and is formed with two conductors 440. The two conductors 440 are partially encapsulated in the surround 432. FIG. 4B is a bottom view of the surround 430′ according to one or more embodiments of the present disclosure. The surround 430′ comprises a surround body 432′ and is formed with two conductors 440′. The two conductors 440′ are completely encapsulated in the surround 432′. The structure and operation of the surrounds 430, 430′ are similar to or the same as the surround 130, and detailed description thereof is omitted.

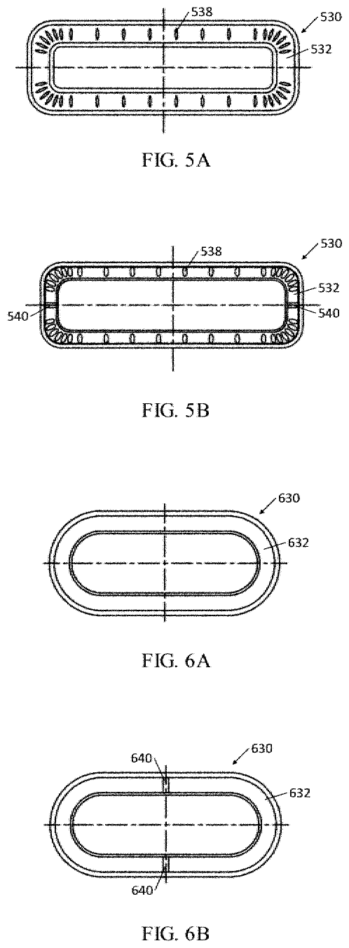

FIGS. 5A-5B show a surround 530 according to one or more other embodiments of the present disclosure, wherein FIG. 5A is a top view of the surround 530 and FIG. 5B is a bottom view of the surround 530. The surround 530 is of a substantially rectangular shape and comprises a surround body 532 and is formed with two conductors 540. The two conductors 540 may be partially or completely encapsulated in the surround body 532. The surround 530 is also formed with a plurality of ribs 538 for improving the structural strength of the surround. In some other embodiments, the ribs 538 may be omitted. Except for the aforementioned difference, the structure and operation of the surrounds 530 are similar to or the same as the surround 130 shown in FIGS. 1-2, 3A-3B, and detailed description thereof is omitted.

FIGS. 6A-6B show a surround 630 according to one or more other embodiments of the present disclosure, wherein FIG. 6A is a top view of the surround 630 and FIG. 6B is a bottom view of the surround 630. The surround 630 is of a substantially oblong shape and comprises a surround body 632 and is formed with two conductors 640. The two conductors 640 may be partially or completely encapsulated in the surround body 632. Except for the aforementioned difference, the structure and operation of the surrounds 630 are similar to or the same as the surround 130 shown in FIGS. 1-2, 3A-3B, and detailed description thereof is omitted.

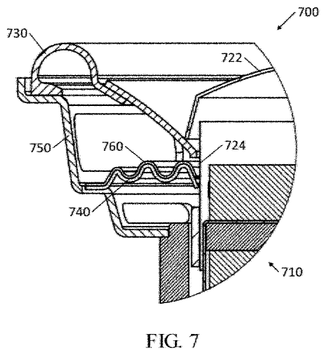

FIG. 7 is a sectional view showing a speaker 700 according to one or more embodiments of the present disclosure. As shown, the speaker 700 comprises a magnet assembly 710 defining a magnetic gap, a diaphragm 722, a voice coil 724, a surround 730, a spider 760, two conductors 740 and a frame 750. The spider 760 is connected at its inner end to the voice coil 724 and is connected at its outer end or outer portion to the frame 750. The conductors 740 are electrically connected to a coil portion of the voice coil 724. As shown, the conductors 740 are formed with the spider 760. Specifically, the conductors 740 comprise a conductor body that is snugly attached to the spider 760 along its entire length, and vibrates with the spider 760 during operation of the speaker 700. In other words, the conductors 740 are connected to the spider 760 and co-extend with the spider 760 at least along an extension length of the spider 760 from the voice coil 724 to the frame 750. During operation of the speaker 700, the voice coil 724 receives an audio signal from an external audio source through the conductors 740. The conductors 740 may be formed with the spider 760 by using a same or similar process as described with reference to the embodiments of FIGS. 1-2, 3A-3B, such as a vulcanization molding process. Except for the spider and the conductors being formed with the spider, the embodiments shown in FIG. 7 may have a similar structure, operation and technical advantages as those described with reference to the embodiments of FIGS. 1-2, 3A-3B, 4A-4B, 5A-5B and 6A-6B, and detailed description thereof is therefore omitted.

According to one or more embodiments of the disclosure, the present disclosure can be implemented as follows.

Item 1: A speaker, comprising:
a magnet assembly defining a magnetic gap;
a frame fixedly attached to the magnet assembly;
a vibration assembly, comprising a diaphragm and a voice coil, the voice coil being attached to the diaphragm and being configured to vibrate with the diaphragm, the voice coil having a coil portion that is at least partially suspended in the magnetic gap, and
a vibration supporting member disposed between the vibration assembly and the frame and connecting the vibration assembly to the frame,
wherein the vibration member is formed with conductors which are electrically connected to the coil portion of the voice coil.

Item 2: The speaker according to Item 1, wherein the vibration supporting member is a surround and the conductors are formed with the surround.

Item 3: The speaker according to any one of Items 1-2, wherein the vibration supporting member is a spider and the conductors are formed with the spider.

Item 4: The speaker according to any one of Items 1-3, wherein the conductors comprise two conductors arranged symmetrically with respect to an axis of the speaker.

Item 5: The speaker according to any one of Items 1-4, wherein the conductors and the vibration supporting member are integrally formed.

Item 6: The speaker according to any one of Items 1-5, wherein the conductors and the vibration supporting member is integrally formed by a vulcanization molding process.

Item 7: The speaker according to any one of Items 1-6, wherein the conductors are single stranded round wires, stranded wires, flat wires, metal films, or metal meshes.

Item 8: The speaker according to any one of Items 1-7, wherein the conductors are partially encapsulated in the vibration supporting member.

Item 9: The speaker according to any one of Items 1-8, wherein the conductors are completely encapsulated in the vibration supporting member.

Item 10: The speaker according to any one of Items 1-9, wherein the conductors are connected to the vibration supporting member and co-extend with the vibration supporting member at least along an extension length of the vibration supporting member from the vibration assembly to the frame.

Item 11: The speaker according to any one of Items 1-10, wherein the magnet assembly comprises a magnet, a top plate and a yoke, and the magnetic gap is formed between the top plate and the yoke.

Item 12: The speaker according to any one of Items 1-11, wherein the speaker has a rectangular shape, a square shape, a circular shape or an oblong shape.

Item 13: The speaker according to any one of Items 1-12, wherein each of the conductors has an inner end electrically connected to the coil portion of the voice coil and an outer end adapted to be electrically connected to an external audio source.

Item 14: An electronic device, comprising one or more speakers according to any of Items 1-13.

Systems and methods have been described in general terms as an aid to understanding details of the disclosure. In some instances, well-known structures, materials, and/or operations have not been specifically shown or described in detail to prevent obscuring aspects of the disclosure. In other instances, specific details have been given to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except considering the attached claims and their equivalents.

1. A speaker, comprising:
a magnet assembly defining a magnetic gap;
a frame fixedly attached to the magnet assembly;
a vibration assembly comprising a diaphragm and a voice coil, the voice coil being attached to the diaphragm and being configured to vibrate with the diaphragm, the voice coil having a coil portion that is at least partially suspended in the magnetic gap, and
a vibration supporting member disposed between the vibration assembly and the frame and connecting the vibration assembly to the frame,
wherein the vibration member is formed with conductors which are electrically connected to the coil portion of the voice coil.

2. The speaker according to claim 1, wherein the vibration supporting member is a surround and the conductors are formed with the surround.

3. The speaker according to claim 1, wherein the vibration supporting member is a spider and the conductors are formed with the spider.

4. The speaker according to claim 1, wherein the conductors comprise two conductors arranged symmetrically with respect to an axis of the speaker.

5. The speaker according to claim 1, wherein the conductors and the vibration supporting member are integrally formed.

6. The speaker according to claim 1, wherein the conductors and the vibration supporting member is integrally formed by a vulcanization molding process.

7. The speaker according to claim 1, wherein the conductors are single stranded round wires, stranded wires, flat wires, metal films, or metal meshes.

8. The speaker according to claim 1, wherein the conductors are partially encapsulated in the vibration supporting member.

9. The speaker according to claim 1, wherein the conductors are completely encapsulated in the vibration supporting member.

10. The speaker according to claim 1, wherein the conductors are connected to the vibration supporting member and co-extend with the vibration supporting member at least along an extension length of the vibration supporting member from the vibration assembly to the frame.

11. The speaker according to claim 1, wherein the magnet assembly comprises a magnet, a top plate and a yoke, and the magnetic gap is formed between the top plate and the yoke.

12. The speaker according to claim 1, wherein the speaker has a rectangular shape, a square shape, a circular shape or an oblong shape.

13. The speaker according to claim 1 wherein each of the conductors has an inner end electrically connected to the coil portion of the voice coil and an outer end adapted to be electrically connected to an external audio source.

14. An electronic device including one or more speakers according to claim 1.

15. A speaker, comprising:
a magnet assembly;
a frame fixedly attached to the magnet assembly;
a vibration assembly comprising a diaphragm and a voice coil, the voice coil being attached to the diaphragm and being configured to vibrate with the diaphragm, the voice coil having a coil portion, and
a vibration supporting member disposed between the vibration assembly and the frame and connecting the vibration assembly to the frame,
wherein the vibration member is formed with conductors which are electrically connected to the coil portion of the voice coil.

16. The speaker according to claim 15, wherein the vibration supporting member is a surround and the conductors are formed with the surround.

17. The speaker according to claim 15, wherein the vibration supporting member is a spider and the conductors are formed with the spider.

18. The speaker according to claim 15, wherein the conductors comprise two conductors arranged symmetrically with respect to an axis of the speaker.

19. The speaker according to claim 15, wherein the conductors and the vibration supporting member are integrally formed.

20. A speaker, comprising:
a magnet assembly defining a magnetic gap;
a frame fixedly attached to the magnet assembly;
a vibration assembly comprising a diaphragm and a voice coil, the voice coil being configured to vibrate with the diaphragm, the voice coil having a coil portion that is at least partially suspended in the magnetic gap, and
a vibration supporting member disposed between the vibration assembly and the frame and connecting the vibration assembly to the frame,
wherein the vibration member is formed with conductors which are electrically connected to the coil portion of the voice coil.
